(19) United States
(12) Patent Application Publication
(10) Pub. No.: US 2005/0264902 A1
(43) Pub. Date: Dec. 1, 2005

(54) Reflector mounted sensor system and method

(76) Inventors: Mark Rennick, Marietta, GA (US); Patricia Rennick, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/124,711

(22) Filed: May 9, 2005

Related U.S. Application Data
(60) Provisional application No. 60/568,916, filed on May 7, 2004.

(51) Int. Cl. G02B 5/08

(52) U.S. Cl. 359/841

(57) ABSTRACT

A reflector-mounted sensor attachable to a vehicle for detecting objects has a sensor configured to detect the presence of an object within a predetermined sensing area of the sensor. A reflector that is configured to reflect light has an opening to receive the sensor so that a facing of the sensor is essentially flush with an outer surface of the reflector. A control unit is coupled to the sensor and configured to receive a predetermined signal associated with detection of an object within a sensing area of the sensor. The control unit is further coupled to an alerting device that may be activated upon detection of the predetermined signal. A plate is coupled to the reflector and is configured to seal the control unit in a compartment created by the reflector and plate.

### CROSS-REFERENCE TO RELATED APPLICATION

This application claims priority to copending U.S. provisional application entitled, “Reflector Mounted Sensor System and Method,” filed May 7, 2004 and having Ser. No. 60/568,916, which is entirely incorporated herein by reference.

### TECHNICAL FIELD

This disclosure pertains to object detection systems relative to a moving vehicle, and more particularly, to a system and method for a reflector mounted sensor to detect potential hazards to a moving vehicle.

### BACKGROUND

Each year, many accidents occur when a driver of a vehicle attempts to move the vehicle in reverse, subsequently resulting in a collision with another object. A driver's view when driving in reverse typically more restricted than when a vehicle is moving forward. As a result, drivers oftentimes rely on rearview mirrors and/or constantly turn and attempt to find obstacles behind the vehicle as the vehicle is moving in reverse. However, due to the relative position of the driver in the vehicle, the driver's vantage point oftentimes results in the failure to see and/or maneuver around various stationary or moving obstacles. Even worse, it is not uncommon for drivers of rear moving vehicles to strike other people who may walk or otherwise move into the path of the rear-moving vehicle, unbeknownst to the driver. In these situations, when the obstacle is a person, such as a child who may dart into the path of the rear-moving vehicle, the consequences can be catastrophic.

Even in relying on rearview mirrors when moving in reverse, a driver still may not be able to see a stationary or moving obstacle that may be in the driver's blind spot. Thus, it has become increasingly common for vehicles to be equipped with object detection systems to aid the driver in handling the vehicle so as to avoid obstacles in the path of the rear-moving vehicle.

At least one solution includes equipping vehicles with automatic sensing systems to detect obstacles, which may include placement of one or more rear facing sensors that emit sonic waves from the rear of the vehicle (or even in other positions, like the front of the vehicle as well). When an obstacle comes within the vehicle's path, the sonic waves may be disturbed and reflected back to the sensor, thereby indicating to the driver via processing electronics that an obstacle is in the path of the rear moving vehicle. Thus, it is possible according to this method to increase the awareness of the driver as to obstacles that may be in the rear (or forward) path of the vehicle so as to prevent damage to the vehicle and/or injury to passengers in the vehicle or other persons that may be within the path as well.

Although current model vehicles may have such systems, the aesthetic appearance of such detection devices generally detracts from the overall appearance of the vehicle. As many upper-end model vehicles have included such object detection systems in the past, the sensors, which may be, as a nonlimiting example, placed in or near the rear bumper of the vehicle, disturb the curves and contours of the vehicle, thereby detracting from the vehicle's stylish design.

As automobile manufactures are acutely aware that customers generally desire a vehicle having a sleek and clean design, the placement of a number of ultrasonic transducers in the vehicle's exterior only detracts from that design goal. Placement of four or more transducers in the rear bumper, as a nonlimiting example, are easily visible to a person standing 50 feet away from the vehicle. This visibility typically results from the fact that the ultrasonic transducers need to have an unobstructed view of the search area proximate to the vehicle so as to be able to detect an obstacle in the search area during driving operations. This design consideration has historically resulted in placement of a sensor's facing at or near the same plane as the bumper's exterior.

Because such sensing devices also have isolators and other materials as part of the assembly and housing, the actual footprint in the exterior surface of the bumper is therefore even larger than the size of the transducer's facing alone. Thus, the assembly is therefore easily visible in the vehicle's bumper or other mounting location, which creates a problem for maintaining stylish design.

Thus, a heretofore-unaddressed need exists to overcome the aforementioned deficiencies and shortcomings.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principals disclosed herein. Moreover, in the drawings, like reference numerals designate corresponding parts throughout the several views.

FIG. 1 is a diagram of a nonlimiting exemplary transducer used with the reflector mounted sensor system and method.

FIG. 2 is a diagram of a nonlimiting exemplary isolator that may be configured to receive the transducer of FIG. 1.

FIG. 3 is a diagram of multiple views of an assembly back plate that may be used to receive the transducer of FIG. 1 and isolator of FIG. 2.

FIG. 3A is a diagram of the assembly back plate of FIG. 3 showing a mounting tab embodiment.

FIG. 4 is a diagram of a reflector lens coupled to the back plate of FIG. 3.

FIG. 5 is a diagram of one assembly process for the sensor/reflector system.

FIGS. 6 and 6A are diagrams of the sensor/reflector assembly of FIG. 5 as prepared for electrical connection to an electronic control unit.

FIG. 7 is a perspective diagram of the sensor/reflector assembly of FIG. 6.

FIG. 8 is an alternative embodiment of the sensor/reflector assembly of FIG. 6 depicting an additional nonlimiting exemplary mounting configuration.

FIG. 9 is a diagram of a back plate for use with the alternative embodiment of FIG. 8.

FIG. 10 is a diagram of an electrical control unit (ECU) that may be electrically coupled to a transducer in the alternative embodiment of FIG. 8.

FIG. 11 is a diagram of the ECU of FIG. 10 coupled with the assemblies of FIGS. 8 and 9.

FIG. 12 is a diagram of a master and slave assembly for the alternative embodiment of FIGS. 8-11.

FIG. 13 is a diagram of the alternative embodiment of FIG. 12 assembly.

### DETAILED DESCRIPTION

In addition to the drawings discussed above, this description describes one or more embodiments as illustrated in the above-referenced drawings.

However, there is no intent to limit this disclosure to a single embodiment or embodiments that are disclosed herein. On the contrary, the intent is to cover all alternatives, modifications, and equivalents included within the spirit and scope of this disclosure and as defined by the appended claims.

This disclosure describes the integration of a sensor and reflector for use in a vehicle to detect objects or other hazards to the vehicle. Additionally, the sensor/reflector system may be used with stationary items for protecting such items by detecting the approach of a moving object. The sensor/reflector system, when used on a vehicle, can provide data to the driver when maneuvering so as to prevent accidents. Additionally, the sensor/reflector system makes automotive travel safer at night, since oncoming drivers can be alerted to the presence of a vehicle equipped with the reflector portion of the sensor/reflector system.

The reflector and sensor assembly share a common construction that one of ordinary skill would in the art would appreciate as eliminating a design calling for a separate housing for each of the sensor and the reflector. Because of this integral design, the assembly is less expensive to manufacture. This cost saving is further enhanced by the fact that the sensor/reflector assembly may be installed in a single labor operation.

The sensor/reflector assembly may be equipped with an ultrasonic transducer or microwave emitter or other type of optical sensor, camera or detection device. One of ordinary skill in the art would know that other types of detection devices may be used as the sensor in the sensor/reflector assembly, and this disclosure is not intended to be limited to any one sensor type or technology.

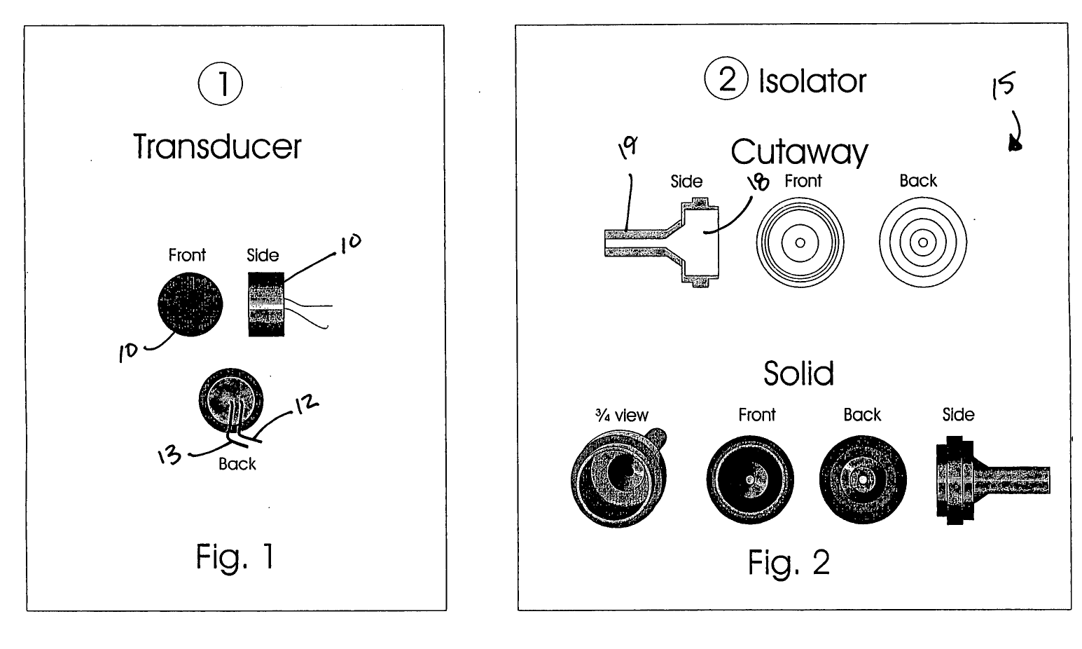

As one embodiment among others, the sensor may be an ultrasonic sensor. FIG. 1 is a diagram of a nonlimiting exemplary transducer used with the reflector mounted sensor system and method. In this embodiment, an ultrasonic transducer 10, as shown in FIG. 1, is combined with an isolator 15 component, as shown in FIG. 2. The ultrasonic transducer 10 in this nonlimiting example may be generally round and have two connectors 12, 13 coupled to the rear of the transducer 10. Ultrasonic energy may be emitted from the front portion of the transducer 10.

The isolator 15 of FIG. 2 has a receiving portion 18 that receives the transducer 10 of FIG. 1. The connectors 12, 13 may be routed through the neck portion 19 to an electronic control unit (ECU). The isolator positions the transducer 10 and assists in directing the ultrasonic energy into the desired area. One of ordinary skill would know that isolator 15 may be shaped in one or more additional configurations than as shown in FIG. 2.

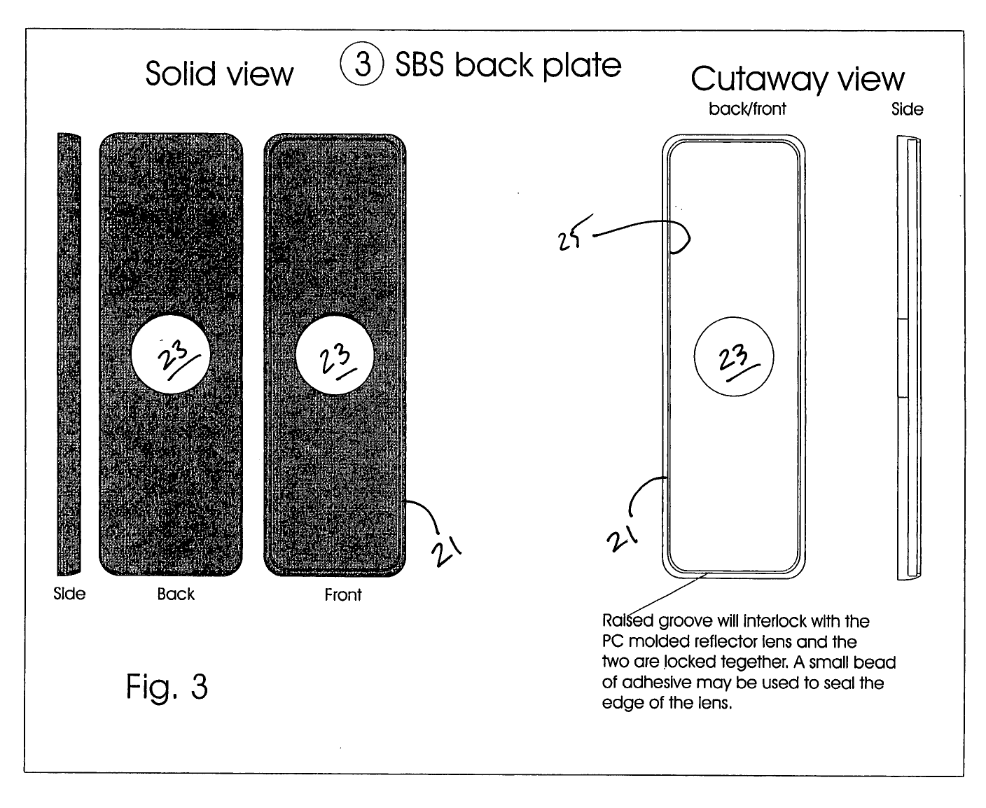

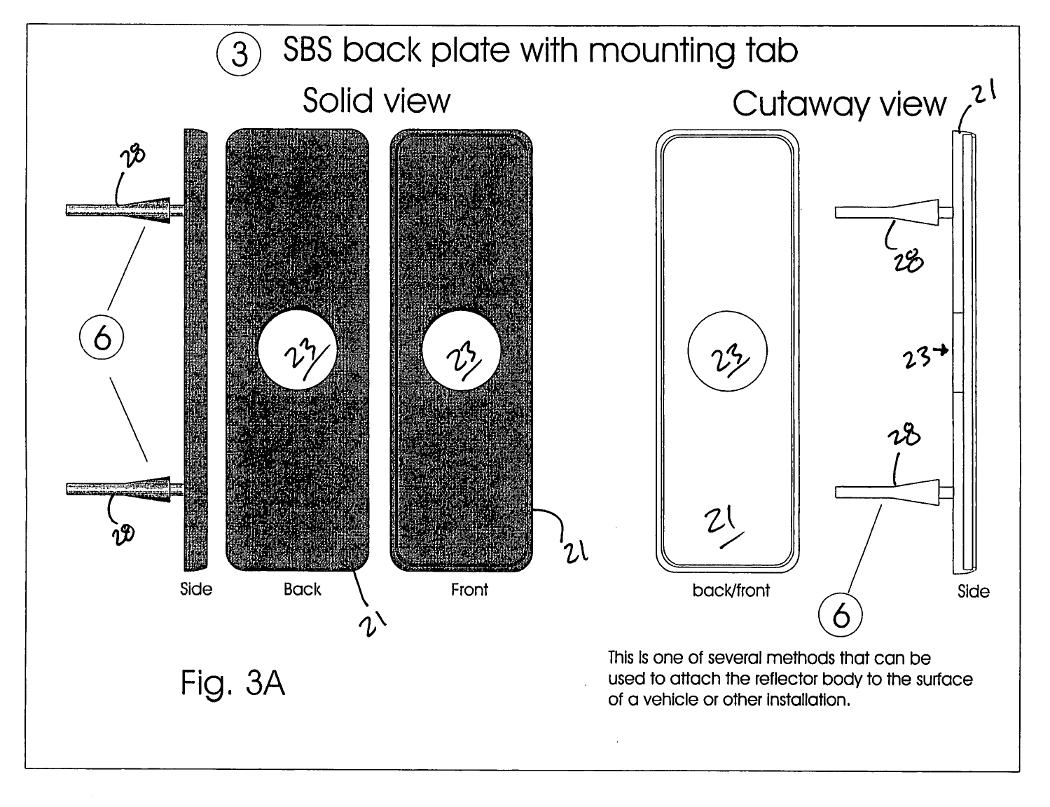

FIG. 3 is a diagram of multiple views of an assembly back plate 21 that may be used to receive the transducer of FIG. 1 and isolator of FIG. 2. Back plate 21 has an opening 23 to receive the isolator 15. In one nonlimiting example, the back place 21 may be fastened by means known to those skilled in the art so that the connectors 12, 13 pass through opening 23 in isolator 15 to transducer 10. As a nonlimiting example, FIG. 3A is a diagram of the assembly back plate 21 of FIG. 3 depicting mounting tab 28 for securing back plate 21 to the vehicle.

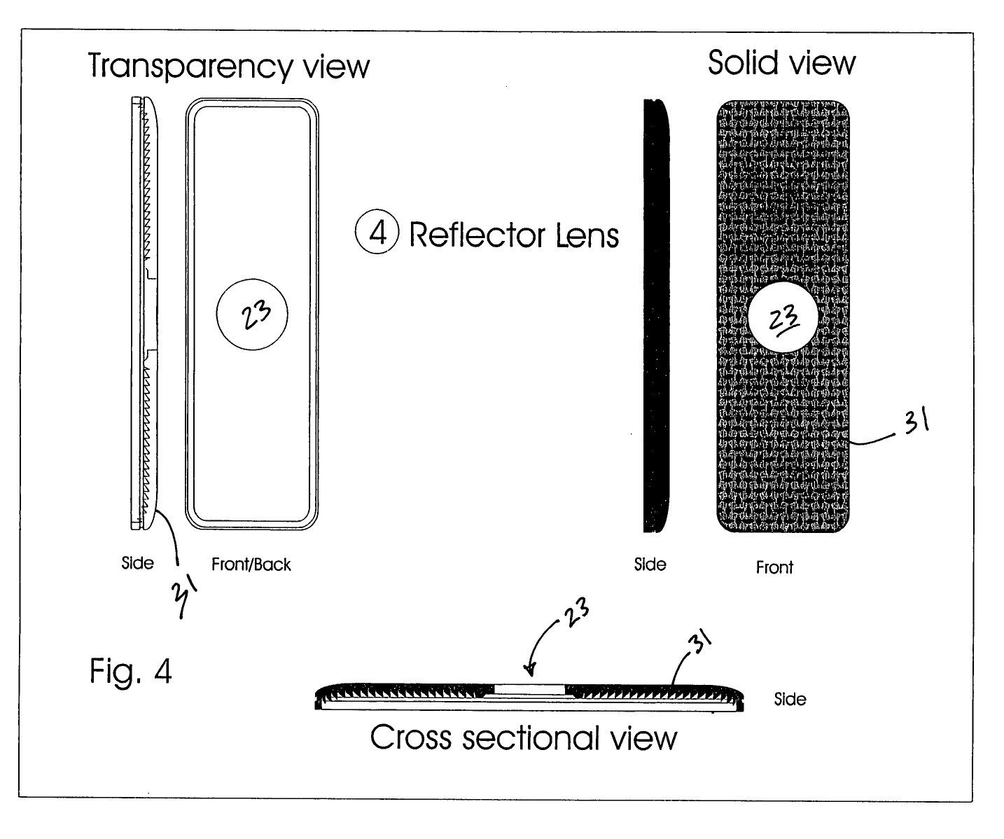

FIG. 4 is a diagram of a reflector lens 31 that may be coupled to the back plate 21 of FIG. 3. The reflector lens 31 also has an opening 23 so that the openings align between the reflector lens 31 and the back plate 21. The back plate 21 (FIG. 3) may include groove 25 for receiving the reflector lens 31.

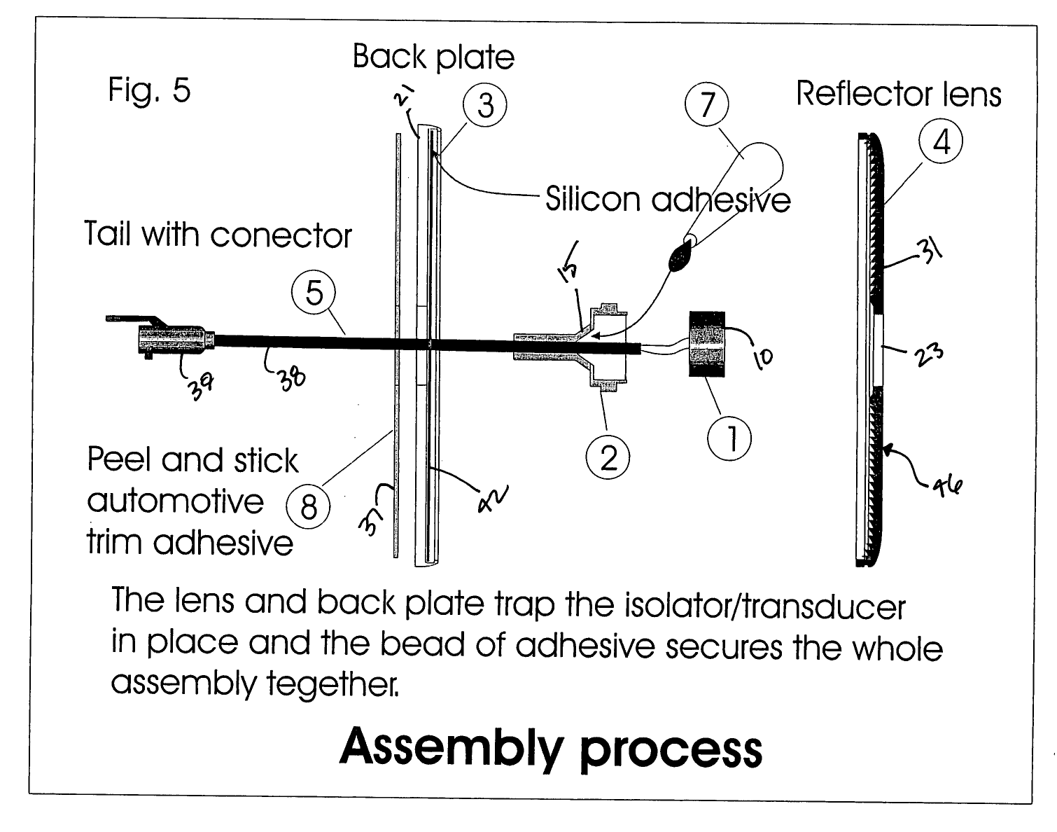

FIG. 5 is a diagram of one assembly process for the sensor/reflector system. The ultrasonic transducer 10 may be positioned in isolator 15 and placed into opening 23. Back plate 21 may be coupled to a vehicle by a peel and stick adhesive 37. Connectors 12, 13 may be contained in wiring harness 38 having plug 39.

An adhesive 41, which in one nonlimiting example is a silicon adhesive may be used to secure reflector lens 31 to back plate 21, that is, in addition to grove 25. Reflector lens 31 may be constructed of a translucent material so as to reflect and scatter light energy that contacts the reflector 31, as one of ordinary skill would know.

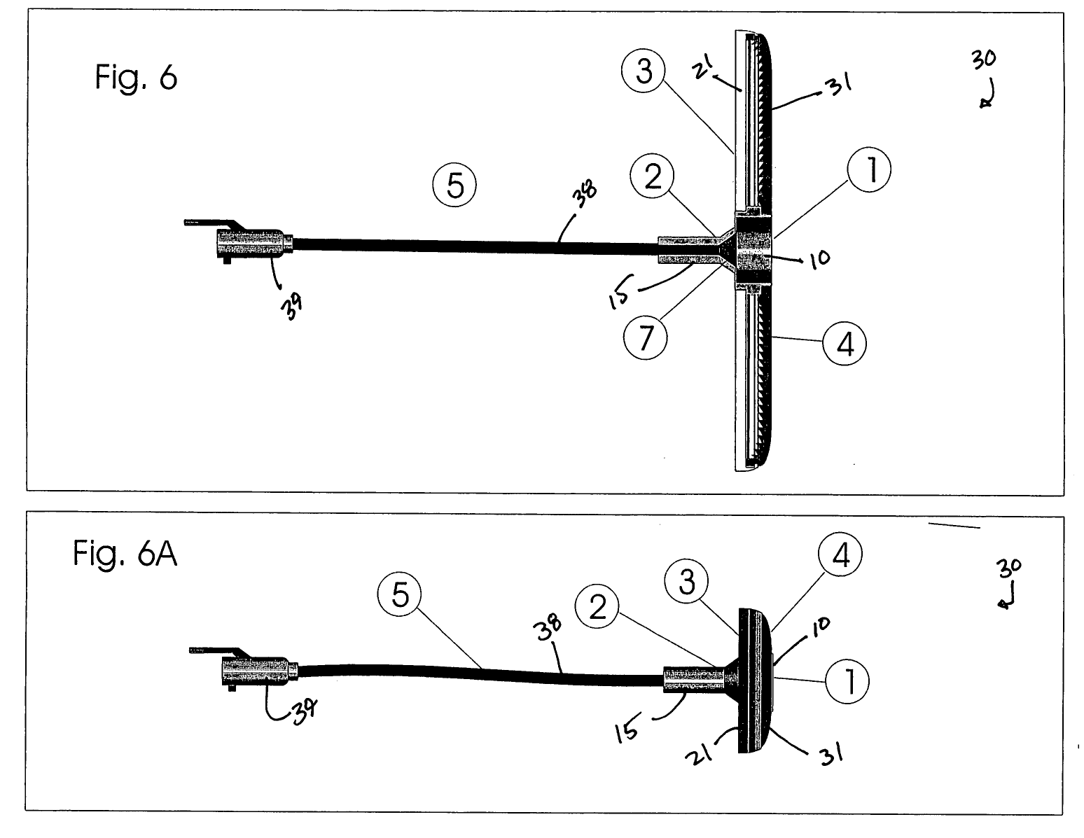

An additional adhesive 43 may be applied to the isolator 15 to secure transducer 10 to the isolator. When mounted in isolator 15, and when isolator 15 is mounted in back plate 21 with reflector lens 31 attached, the front surface of transducer 10 is essentially flush with the outer surface 46 of reflector lens 31. The facing of transducer 10 may also be color-coded to match that of reflector lens 31. Upon assembly of these items, the sensor/reflector assembly 30 may appear as shown in FIGS. 6 and 6A, which top and side diagrams of the sensor/reflector assembly of FIG. 5. As shown in FIGS. 6 and 6A, the transducer 10 is essentially flush with surface 46 of reflector 31.

In operation, reflector lens 31, as shown in FIG. 6, reflects light that contracts the reflector lens 31. However, transducer 10, if coupled to an ECU, may be configured to emit and receive ultrasonic (or other signal energy) from the position in the assembly 30 shown in FIGS. 6 and 6A.

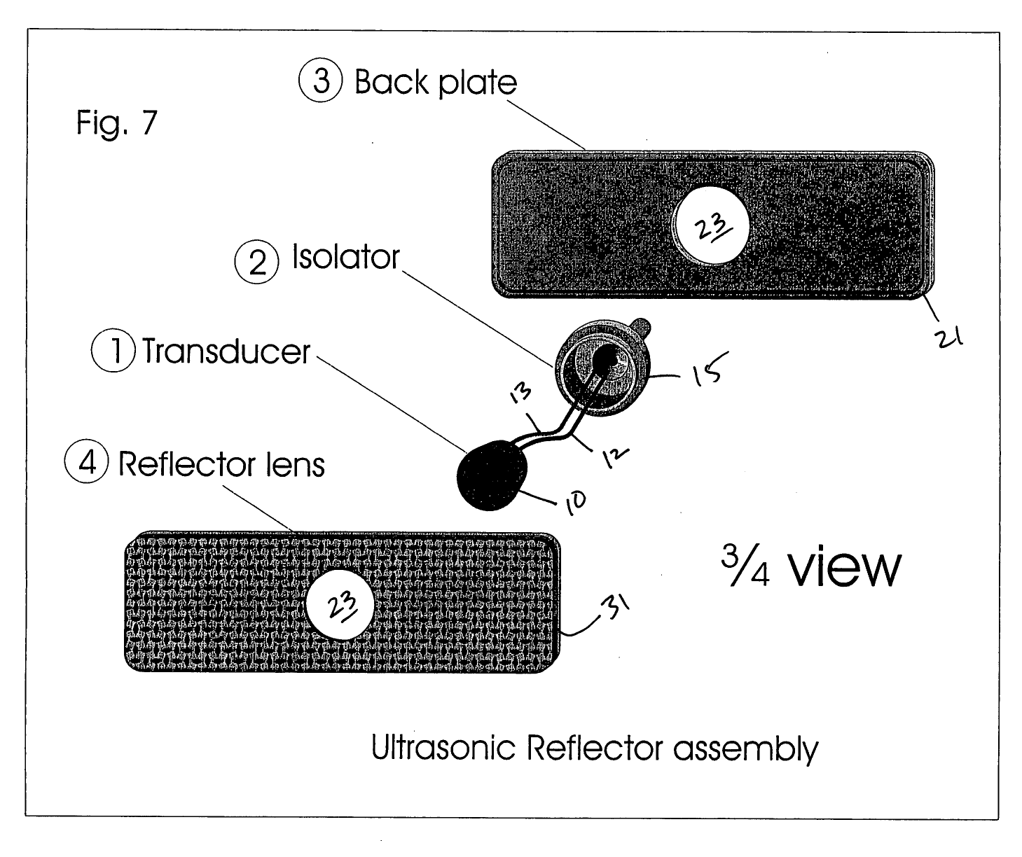

FIG. 7 is a perspective diagram of the sensor/reflector assembly of FIG. 6. This diagram depicts the relationship of reflector lens 31, transducer 10, isolator 15, and back plate 21. As discussed above, isolator 15 and transducer 10 fit within the openings 23 in each of reflector lens 31 and back plate 23. So while a portion of the reflective area of reflective lens 31 is consumed by the transducer 10 (and isolator 15), the majority of reflector lens 31 is still capable of reflecting light, such as to other vehicles that may be approaching a vehicle equipped with the sensor/reflector assembly 30 of FIG. 6.

The reflector/sensor assembly 30 may also include a processor 50 to convert the sensor data received by transducer 10 to useful information for the driver of the vehicle or to the individual monitoring the transducer 10. The processor 50 may be any type of electronic processing device that accepts input from the transducer 10 and produces one or more corresponding outputs, which may be used for visual and/or audio indication of a hazard detected by a sensor.

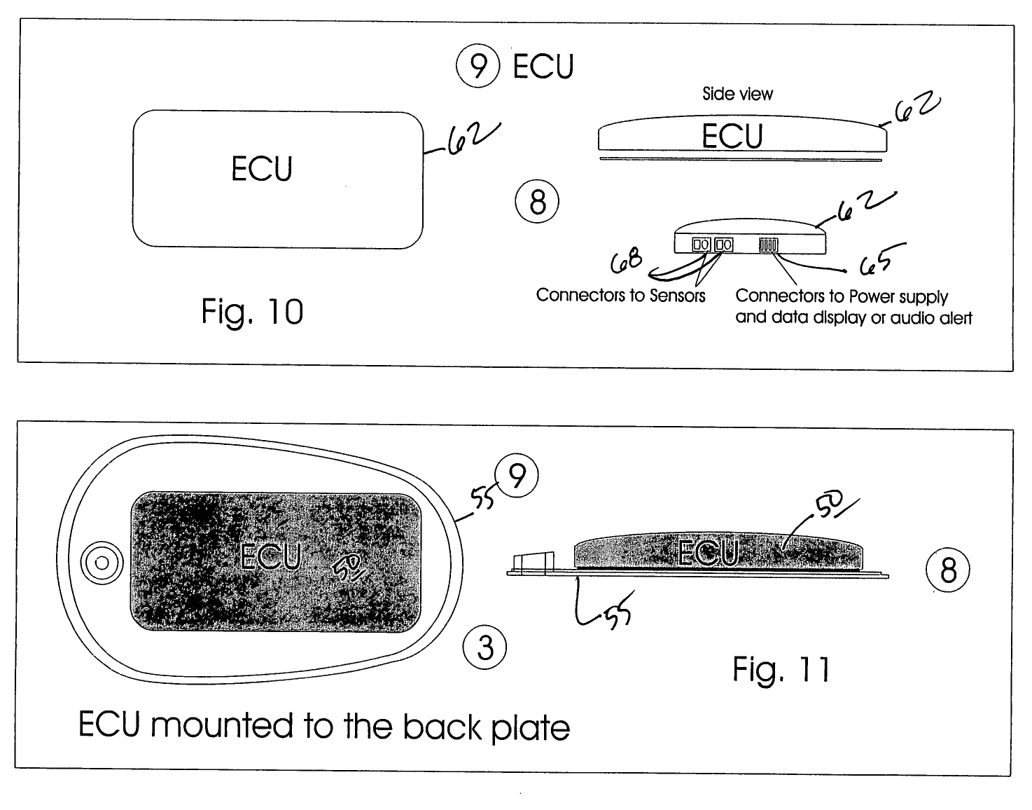

The processor 50, which is depicted as the electronic control unit (“ECU”) in FIG. 10, can also be included in the reflector/sensor assembly housing. Incorporating the ECU and reflector/sensor into a single housing reduces the cost of production as common components are shared, thereby reducing installation costs.

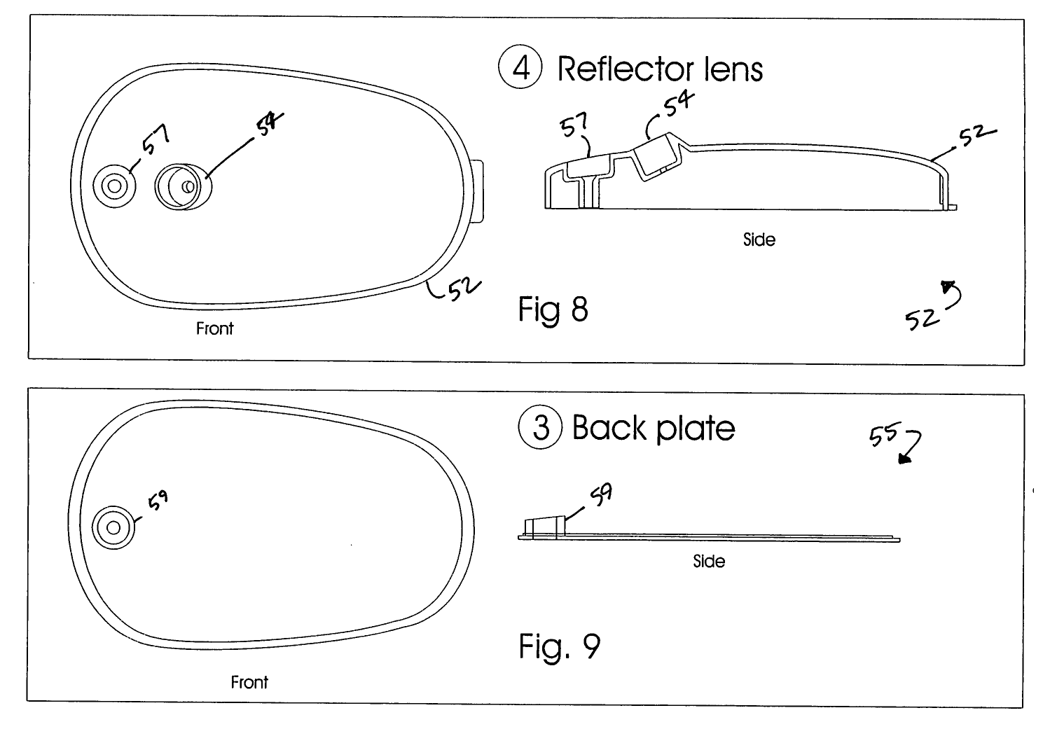

FIG. 8 is an alternative embodiment of the sensor/reflector assembly 30 of FIG. 6 depicting an additional nonlimiting exemplary reflector lens 52. FIG. 9 is a diagram of a back plate 55 for use with the alternative embodiment of FIG. 8.

In this nonlimiting example, isolators 54 and 57 are configured into the reflector lens 52, thereby simplifying manufacturing and installation. Isolator 54 is angled so that a transducer 10 may direct ultrasonic energy into a desired area relative to the reflector lens 52. As a nonlimiting example, if reflector lens 52 were positioned along a side area of a vehicle, the isolator 54 may be oriented so as to direct ultrasonic energy into an area to the rear or beside the vehicle. Thus, one of ordinary skill would know that isolator 54 could be oriented in a variety of angles respective to reflector lens 52 depending upon the desired area for directing ultrasonic energy.

Instead of portion 54 on reflector lens 57 being used for housing a transducer, it may instead be used for receiving a screw or other attaching mechanism for fastening the assembly 69 to a vehicle.

FIG. 10 is a diagram of the electrical control unit (ECU) 62 that may be electrically coupled to a transducer 10 in the alternative embodiment of FIGS. 8 and 9. The ECU 62 is a processing unit, as one of ordinary skill in the art would know, such as a device including a processor, a memory at least containing operating software, one or more inputs (i.e., transducer signal inputs, power supply, etc.), and one or more outputs (i.e., alerting device, other ECUs, other transducers, etc.). ECU 62 may have power input 65 and sensor inputs 68, which may be coupled to connectors 12, 13 for transducer 10.

ECU 62 receives signal inputs from transducer(s) 10 and is configured to recognize a predetermined signal from the transducer 10 as connoting the detection of a hazard or obstacle within the sensor area of the particular transducer 10. ECU 62 may have one or more outputs coupled to one or more alerting devices, such as a buzzer, horn, light, etc. to announce the detection of an obstacle by one or more transducers 10.

FIG. 11 is a diagram of the ECU 62 of FIG. 10 coupled with the back plate 55 of FIG. 9. ECU 62 may be coupled to back plate 55 by any method known to one or ordinary skill in the art. The consolidation of the transducer 10, reflector lens 52, and ECU 62 into a single housing (including back plate 55) permits combination with additional reflector sensors in the housing, which creates a larger detection field or a network of sensors that interface with a single common ECU.

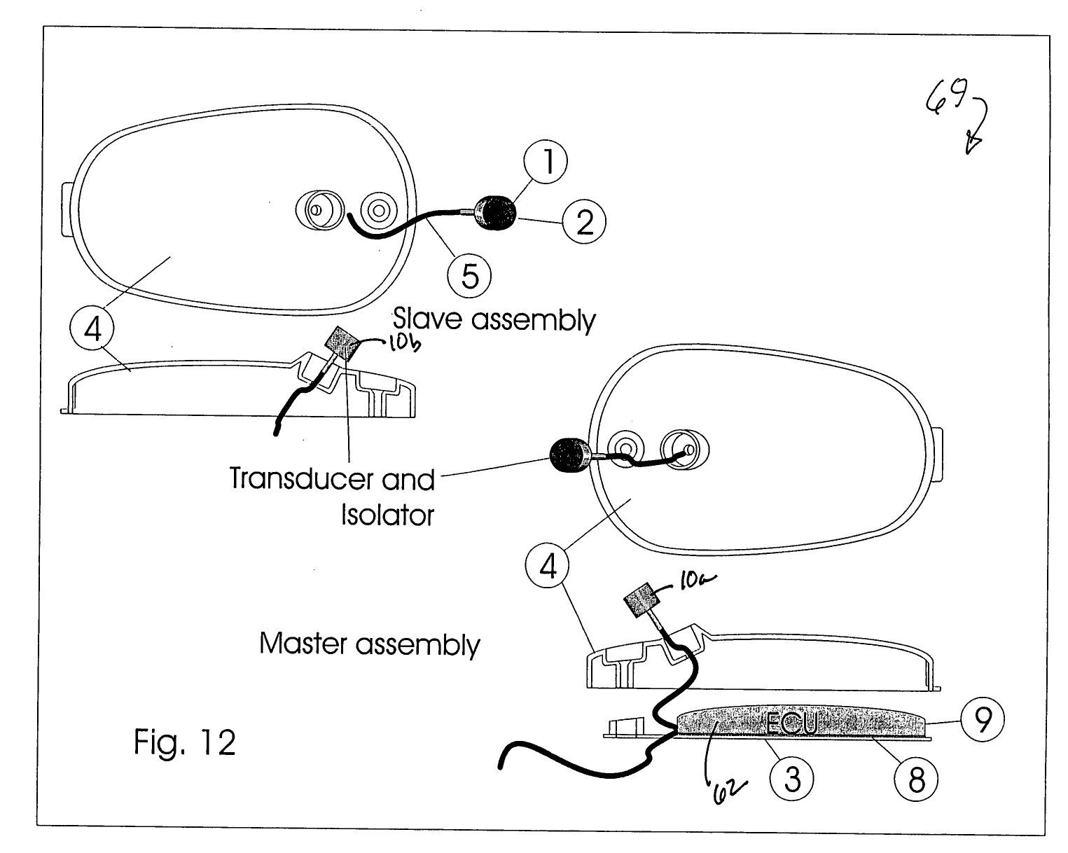

FIG. 12 is a diagram of a master and slave assembly for the alternative embodiment of FIGS. 8-11. This diagram depicts two transducers 10a, 10b coupled to a single ECU 62. The associated connectors between transducers 10a, 10b and ECU 62 enable the reflector lenses 52a and 52b to be disparately positioned on the vehicle to detect obstacles in different areas proximate to the vehicle. Thus, the detection area of the system can be scaled appropriately depending upon the number of sensor transducer assemblies 69 (FIG. 12) are positioned on the vehicle. The various sensor reflector assemblies may be positioned on the vehicle in an aesthetically pleasing manner so that ordinary observers would not otherwise notice their presence on the vehicle. Plus, the reflector sensor assemblies 69 may perform the dual task of reflection and obstacle detection, a double safety feature benefit for the driver of the vehicle.

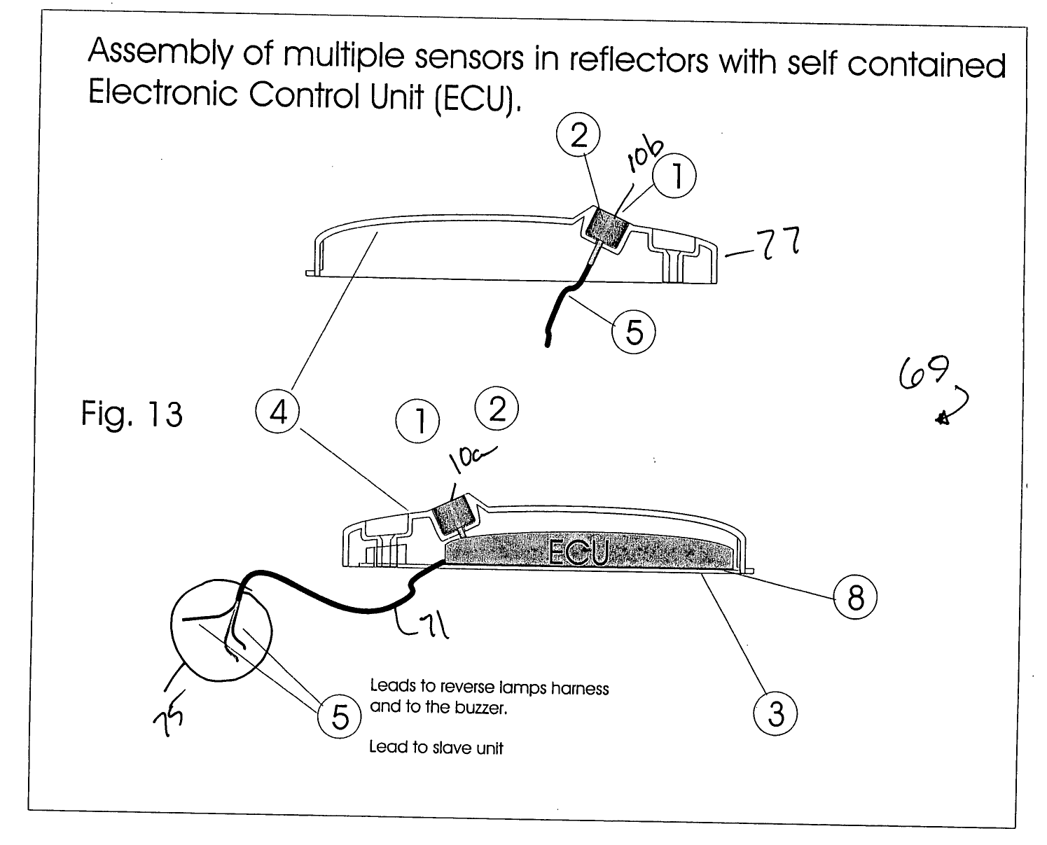

FIG. 13 is a diagram of the sensor assembly 69 of FIG. 12 showing the ECU 62 enclosed within the reflector lens 52 and back plate 55. A wire harness 71 includes connectors 75 that may be coupled to the slave assembly 77 having a transducer 10b. Wire harness 71 may also be coupled to an alerting device, as described above. This sensor assembly 69 protects the ECU 62 from weather and other hazards that could otherwise damage ECU 62.

The drawings depict multiple combinations of the sensor/reflector assembly as well as manufacturing techniques that may be used to produce the sensor/reflector assemblies disclosed herein. The drawings are not indicative of any specific styling or configuration that may be required, as one of ordinary skill in the art would know that other configurations of the sensor, reflector, and ECU may be implemented without varying from one or more of the embodiments of this disclosure.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. A reflector-mounted sensor attachable to a vehicle for detecting objects, comprising:
a sensor configured to detect the presence of an object within a predetermined sensing area;
a reflector configured to reflect light and having an opening to receive the sensor so that a facing of the sensor is essentially flush with an outer surface of the reflector;
a control unit coupled to the sensor and configured to receive a predetermined signal associated with detection of an object within a sensing area of the sensor, and further coupled to an alerting device that may be activated upon detection of the predetermined signal; and
a plate coupled to the reflector and configured to seal the control unit in a compartment created by the reflector and plate.
